(19) United States
(12) Patent Application Publication
(10) Pub. No.: US 2002/0039607 A1
(43) Pub. Date: Apr. 4, 2002

(54) Coaxially combined meat roast with steaks or chops cut from same

(76) Inventor: William Younger Guess, Baton Rouge, LA (US)

Correspondence Address: William Younger Guess, 1144 Parlange, Baton Rouge, LA, 70806, US

(21) Appl. No.: 09/964,000

(22) Filed: Sep. 26, 2001

Related U.S. Application Data
(60) Provisional application No. 60/235,675, filed on Sep. 27, 2000.

(51) Int. Cl. A23L 1/31

(52) U.S. Cl. 426/92

(57) ABSTRACT

A coaxially combined meat roast (10) is disclosed which comprises a first solid elongated meat mass (12) encasing as a core element along substantially the longitudinal axis thereof within a longitudinal slit-like aperture incised therethrough, a vegetably veneered second solid elongated muscle meat mass (20).

This application is entitled to the benefit of Provisional Patent Application Ser. No. 60/235,675 filed Sep. 27, 2000.

### BACKGROUND

1. Field of the Invention

This invention relates generally to meat roasts and specifically to a coaxially combined meat roast in which a first solid elongated muscle tissue mass encases as a core element a second vegetably veneered solid elongated muscle tissue mass.

2. Background of the Prior Art

Currently there is among meat packers a trend toward “case ready” and “portion controlled” meat products, meaning that wholesale packers are assuming more roles traditionally held by retail butchers, meat cutters and even chefs. “Case ready” refers to those products or cuts, which are shipped to retail markets with no further cutting or manipulation needed. “Portion controlled” describes those products or cuts intended for food service applications, also with little or no further cutting and/or manipulation and portioned out to determine an accurate cost per serving. There is also an aim in the meat processing industry, retail butchery and retail food service toward providing low fat meat items in response to the wants of health conscious consumers. There is also a trend toward providing meat items with enhanced visual appearance, these items are sometimes referred to as “center of the plate” items.

Among the primal meat cuts, the longitudinally bisected lumbar section, also called the half saddle or short loin, is generally considered the most choice, in that it contains significant portions of both the top loin and the tenderloin muscle tissue groups which, in and of themselves, are considered excellent cuts. The most prominent muscle in the top loin is the longissimus dorsi, which is actually a long band of muscle segments which extend down the dorsal side of the transverse processes of the spinal column and the ribs, from the base of the neck to the hip. The most prominent muscle in the tenderloin is the psoas major. One of the problems associated with the short loin cut are due to the spinal bones, which support and secure these muscle-based tissues. In times long past whole loins or saddles of food animals were commonly served at banquets, homes and restaurants. These saddles were roasted whole, carved from the bones then sliced for service. This required a skillful carver. This method also tended to over cook the tenderloin, which is usually half the diameter as that of the top loin. One solution has been to remove these meats from their respective bones and to cook and serve separately. While this method works reasonable well with large animals such as beef cattle, of which the tenderloin is of sufficient size to portion out to diners, this method fails, in this regard when considering a smaller food animal such as lamb, in which the tenderloin is very small by comparison to that of beef cattle. Currently tenderloins of lamb are often used as an ingredient in salads. Another problem with boning out and separating the tenderloin and top loin is that some diners enjoy both the top loin and the tenderloin in a single serving as is the case with T-bone or Porterhouse steaks and T-bone chops. T-bone and Porterhouse steaks, the often menu described “best of both worlds” method, while providing portions of both the tenderloin and the top loin, does not solve the problem of the spinal bones, which are present in these cuts. Many diners avoid bone-in meat products due to the dissection required for the consumption thereof Another problem with this method is that due to the taper of the tenderloin, T-bone steaks by definition have smaller portions of the tenderloin than do the Porterhouse steaks. Also the Porterhouse steak comes from that portion of the lumbar section in which the gludimus medius muscle begins to supplant the longissimus dorsi in the cross section thereof. The boundaries between these muscles contain fascia or, silverskin as it is know in the art, which puts off many diners as being gristly.

Another problem associated with the boned out top loin is that this cut lacks visual appeal. It is for this reason that the rack or rib sections of pork, veal, lamb or venison appear much more commonly on restaurant menus than do their respective boneless top loins. The trimmed or “frenched” rib bones add visual appeal to these cuts despite being arguably of lesser quality than that of the boneless top loin which lacks “center of the plate” pizzazz. The rib sections suffer from the fact that the longissumus dorsi contained therein becomes gradually and progressively supplanted in the cross section thereof by amongst other muscles, the spinalis dorsi. The spinalis dorsi and other muscles bring with them tough fascia and untrimable intermuscular fat to the rib section.

One prior art attempt at producing a boneless short loin roast has been to remove the tenderloin from the short loin, then to remove the spinal bones but leaving the top loin connected to a flap-like meat segment sometimes called the “skirt” that extends outwardly therefrom. The boneless short loin is then reassembled by positioning the tenderloin along side of and adjacent to the top loin, then, folding the skirt over both the tenderloin and the top loin and securing the whole with butchers twine, forming essentially a laced package. This package technique is often applied to a whole saddle of lamb in which the two tenderloins and the two top loins are present, often with a vegetable based stuffing filling the gaps between the tenderloins and the top loins. These package-type reassembled roasts are then roasted whole and sliced for service, or sliced into individual portions, securing with a skewer then grilled or fried. While this method provides a boneless tenderloin/top loin combination, it suffers from the following deficiencies, (a) the skirt tissues contain a high proportion of fat and connective tissues which some diners don't enjoy chewing and/or consuming, (b) this method is difficult and time consuming to perform, and (c) the finished product lacks visual appeal as it tends to fall apart during cooking, tuning, slicing or plating.

Another prior art method which provides a boneless and combined tenderloin/top loin roast requires the boning out of a short loin, trimming the top loin and the tenderloin, butterflying the top loin, placing the tenderloin on one edge of the splayed out top loin then rolling up the tenderloin within the splayed out top loin and securing this rolled roast with butchers twine or netting. While this roulade-type method provides a boneless tenderloin/top loin combination with reduced connective tissues it (a) requires a difficult and time consuming operation, (b) requires the step of securing the roast with butchers twine or netting, (c) during the cooking process, shrinkage of the top loin tissues can expose the tenderloin when there is insufficient over-lap, thus impairing already limited visual appeal.

A prior art method with the aim of enhancing the appearance of a boneless top loin has been to stuff a sausage type mixture into a cavity incised and hollowed within the longitudinal axis thereof This hollowing out of the top loin incision is sometimes effected by wallowing a sharpening steel in a narrow slit-like aperture having been incised therethrough, tearing, stretching and compressing the tissues thereby. Another prior art method again with the aim of improving the appearance of a pork loin has been to force a portion of frozen link-type sausage into a cross-like pair of perpendicular incisions incised through the boneless pork top loin While the above sausage additions add somewhat to the visual appeal of the top loin they put off the diners that avoid these fatty, gristly products due to health, religious and/or taste considerations. Some diners are leery of sausage products in that they cannot be certain as to the type of animal(s) used in the making thereof. Presently there is also great concern for certain type of tissues which sometimes are accidentally included in sausage meat particularly thyroid, brain or spinal cord tissues. Additionally a problem associated with the cross-like longitudinally incised top loin is that while this technique can work reasonably well with cylindrical shaped sausage items having a cross section diameter that is proportionally small when compared to that of the pork top loin, these type incisions fail when a proportionally larger, sometimes irregularly shaped muscle meat items such as tenderloins are concerned in that these larger items would tend to rip open one or more of these incisions especially since the top loin has a rather elliptical cross-section.

Still another problem facing chefs and meat cutters concerns the narrow tip of certain meat items such as that of the beef tenderloins. Currently when whole beef tenderloins are roasted whole the tenderloin tip is usually doubled back and folded under itself adding to the cross section thereof and reducing the likelihood of over cooking the very narrow tip. While this technique reduces the problem of overcooking the tip somewhat, it offers to those diners that receive it an unattractive bifurcated portion

Another problem with the short loin is that while it contains the best section of the longissimus dorsi, it does not contain the best section of the psoas major which originates beneath the lumbar or short loin transverse processes and continue along the ilium and inserts onto the femur, well past the end of the longissimus dorsi. Therefore the term “best of both worlds” is a misnomer in that at no point along the short loin do we find the best part of the longissimus dorsi paired with the best part of the psoas major because at the point along the carcass where the psoas major reaches its largest diameter the longissimus dorsi has already begun to taper and become supplanted by the gludeus medius and the untrimable gristle found therebetween.

### OBJECTS AND ADVANTAGES

Accordingly, several objects and advantages of the present invention are to provide a boneless meat roast which (a) is comprised of both the tenderloin and the top loin, (b) can be produced quickly and easily, (c) has strong visual appeal for customer acceptance, (d) contains little or no gristle or intermuscular fat, (e) requires no butchers twine or netting for the construction, portioning, transport, cooking, turning or plating thereof, (f) top loin tissue shrinkage Will not expose the tenderloin during the cooking and/or the serving thereof, (g) provides a true “best of both worlds” steak and (h) contains no sausage product.

### SUMMARY

In accordance with one embodiment of the present invention a coaxially combined meat roast comprises a boneless top loin encasing as a core element a vegetably wrapped tenderloin within a slit-like aperture incised throughout the longitudinal axis thereof.

### DRAWINGS

### Drawing Figures

In the drqwings, closely related figures have the same number but different alphabetic: suffixes. Further aims and advantages of the present invention will be better understood during the following description, regarded as a mere non-limiting example and referring to the enclosed drawings, in which:

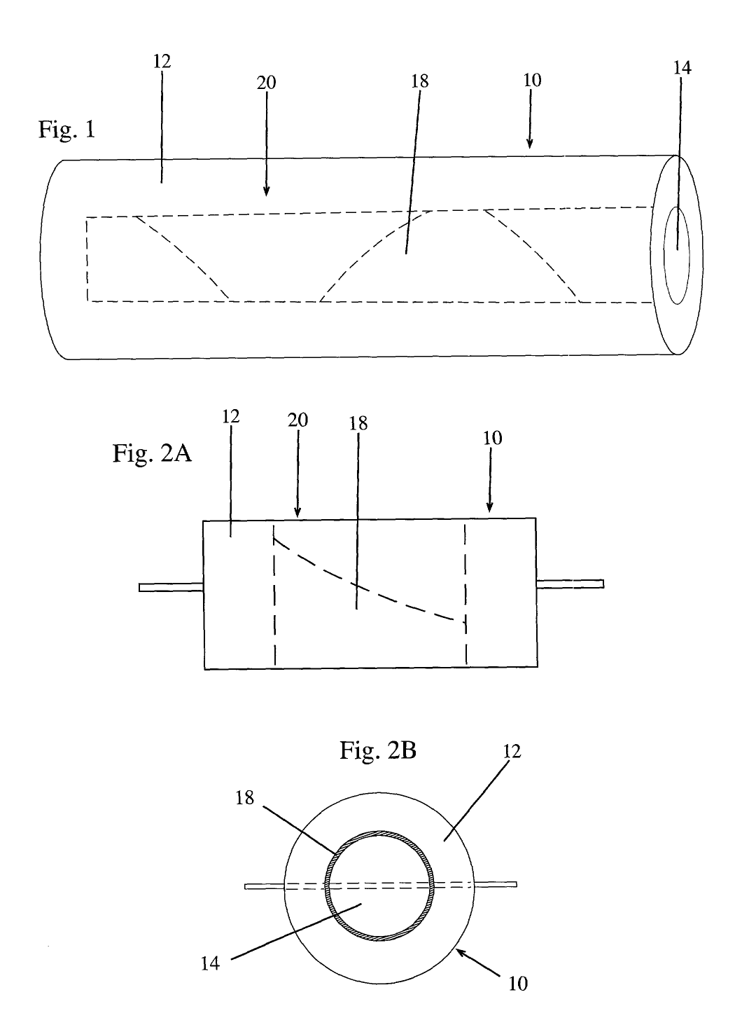

FIG. 1 shows a perspective view of a coaxially combined meat roast with a leafy vegetable wrapped tenderloin.

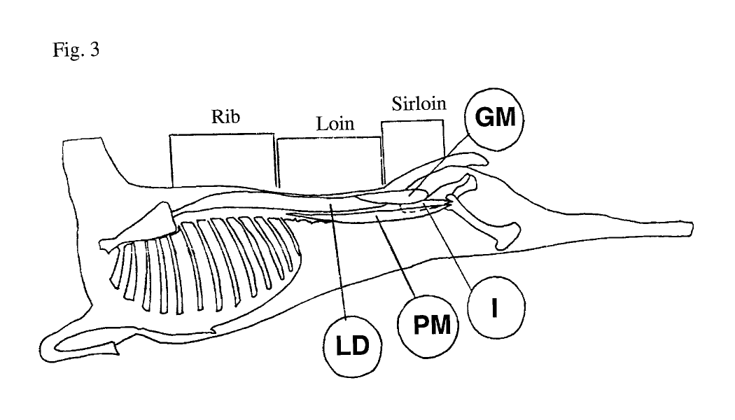

FIG. 2A shows a side view of a steak removed from the coasially combined meat roast with leafy vegetable wrapped tenderloin with a skewer inserted laterally through the whole thereof.

FIG. 2B shows a top view of the steak removed from the coaxially combined meat roast.

FIG. 3 is a diagrammatic side elevation of a typical four legged fur bearing food animal showing the approximate size and location of the rib, loin and sirloin sections. Four muscles are shown and are designated as follows: LD—longissimus dorsi; PM—psoas major; I—iliacus and; GM—gludeus medius.

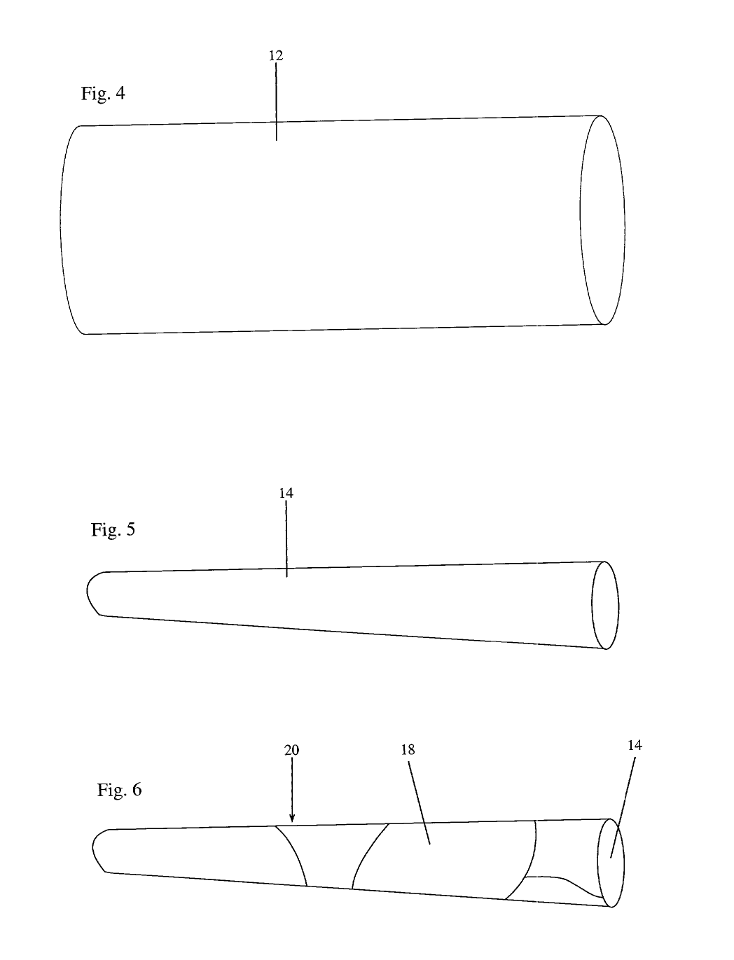

FIG. 4 shows a boneless trimmed length of top loin.

FIG. 5 shows a boneless trimmed length of tenderloin.

FIG. 6 shows the boneless trimmed length of tenderloin which has been laterally enrobed with a leafy vegetable overlay.

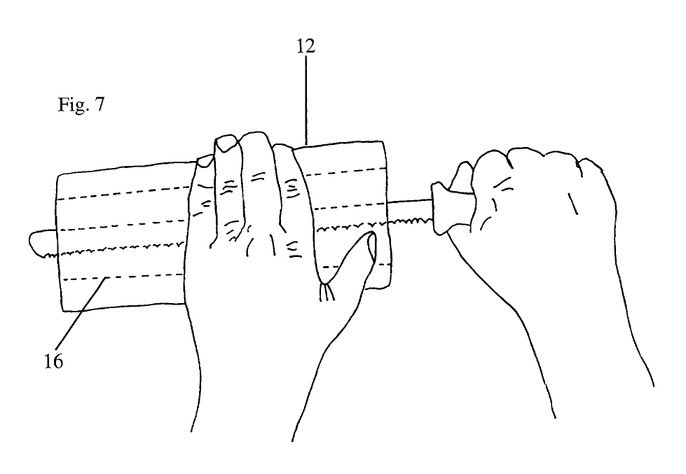

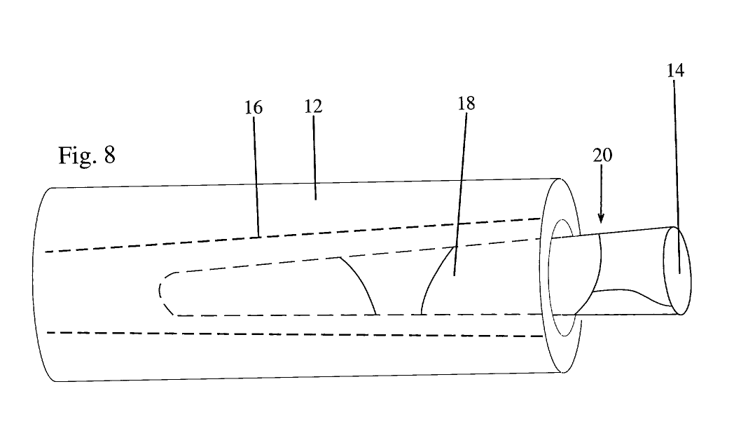

FIG. 7 shows a method of incising a slit like aperture within the top loin.

FIG. 8 shows the incised top loin in which the vegetably veneered tenderloin is partially inserted.

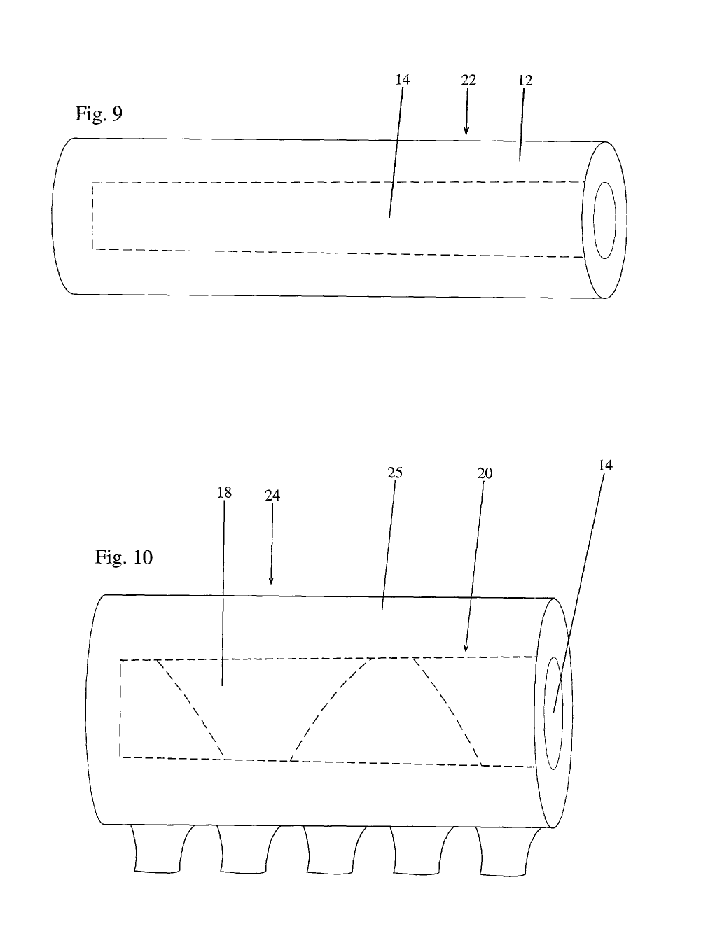

FIG. 9 shows a coaxially combined meat roast without the leaf type vegetable wrap.

FIG. 10 shows a coaxially combined meat roast made with a rib section.

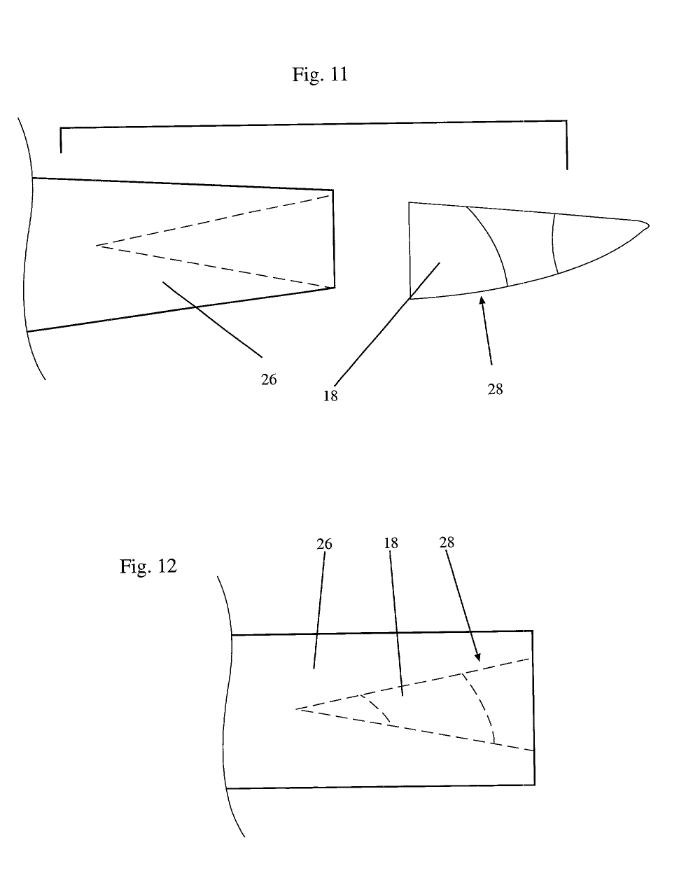

FIG. 11 shows a partial view of a narrowing food muscle in which the tip portion has teen removed and onto which a vegetable overlay has been added and a v-shaped slit-like aperture has been incised into the main body thereof

FIG. 12 shows a coaxially combined meat roast made from the tip removed narrowing food muscle and the vegetably veneered tip thereof.

### DETAILED DESCRIPTION OF THE PREFERRED EMBODIMENTS

One preferred embodiment of a coaxially combined meat roast is show in FIG. 1. The coaxially combined meat roast 10 comprises both a top loin 12 and a vegetably veneered tenderloin 20 (shown using hidden lines) which is comprised of a tenderloin 14 which has been laterally enrobed by segments of leafy vegetable material 18 (also shown using hidden lines). The top loin 12 contains as a core element the vegetably veneered tenderloin 20 which has been inserted in an aperture having been incised throughout the top loin 12. FIG. 2A (slightly enlarged) and FIG. 2B show a side and top view respectively of a steak cut from the coaxially combined meat roast that has been secured for cooking, tuning, and serving with a skewer.

FIG. 3 shows a diagrammatic side elevation of a food animal carcass and illustrates the misalignment of the longissimus dorsi s(top loin) with respect to the psoas major (tenderloin). Also shown in this drawing are the approximate size and location of the gludeus medius and iliacus muscles.

The present inventions requires removing a portion of the top loin and the tenderloin from the spinal column of a food animal (not shown). It is preferable that the fascia or, as it is also known in the art “silverskin” be removed from the top loin (not shown). It is preferable that the iliacus be removed from the tenderloin (not shown). It is also preferable that the “chain” or psoas minor be removed from the tenderloins of all animals including and larger than mature swine (not shown). It is also preferable that the fascia be removed from the tenderloins of all animals including and larger than mature swine (not shown).

FIG. 4 shows a trimmed top loin 12. FIG. 5 shows trimmed tenderloin 14. In order to aid in the leaf segment overlay process and the insertion of the veneered tenderloin 20, the trimmed tenderloin 14 is first at least crust frozen by subjecting it to a subfreezing environment for a time period sufficient to make the tenderloin 14 rigid Devices and processes are known to the art that rely on cryonic fluids to freeze meat items very rapidly and could be ideal for this step.

The crust frozen tenderloin is then covered with blanched green leafy vegetable segments or sheets such as spinach, turnip leaves, collard leaves, nori or the like. The leaf segments 18 are applied starting at the hip end of the tenderloin 14 and are overlapped much like roof tiles until the entire tenderloin is covered laterally around the circumference thereof. The dampness of the blanched leaf segments 18 and the subfreezing temperature of the surface of the crust frozen vegetably veneered tenderloin 20 shown in FIG. 6 is preferably lubricated lightly with an edible lubricant such as olive oil, vegetalbe oil and the like (not shown).

The trimmed top loin 12 is incised as shown in FIG. 7 in order to create an aperture 16 of sufficient size to accommodate the vegetably veneered tenderloin 20. Having a rather elliptical cross cross section the top loin 12 is positioned with one of the wide sides thereof contacting the work surface. The incision is made by inserting a thin serrated knife into the center of one end of the trimmed top loin 12 then piercing through the central axis thereof exiting the center of the opposite end thereof. Using a sawing motion and cutting parallel to the work surface, the aperature is enlarged throughout the top loin 12 by cutting, using a sawing motion, throught the top loin tissue to a distance slightly more than half the diameter as that of the veneered tenderloin 20. The knife is then rotated 180 degrees and having returned to the center point of the top loin 12, the cutting process is repeated in the opposite direction converting the top loin with the addition of this slit-like aperture 17 into essentially a collapsed tubular preform. FIG. 8 shows the lubricated crust frozen vegetably veneered tenderloin 20 partially inserted into the incised top loin 20.

### ADDITIONAL EMBODIMENTS

Two alternate embodiments of the present invention are shown in FIGS. 9 and 10. In FIG. 9 there is shown a coaxially combined roast 22 similar to that of the previous embodiment in which the tenderloin 14 has no vegetable over-lay. Another embodiment of the present invention as shown in FIG. 10 is a coaxially combined meat roast 24 in which a rib sectrion 25 encases as a core element a vegetably veneered tenderloin 20. As some diners enjoy the rib bone in place on sliced roasts or racks, steaks or chops, the addition of the tenderloin with the concentric vegetable ring would give a similar appeal to those cuts.

Another alternate embodiment of the present invention is shown in FIGS. 11 and 12. FIG. 11 shows the narrowing end portion 26 of a food muscle such as the hip or chuck end of a longissimus dorsi or the lumbar end of a psoas major, the tip end thereof 28 having been removed and crust frozen, enrobed with vegtetable material 18 and lubricated with an edible lubricant. Shown in FIG. 12 the narrowing shortened end portion 27 having been incised with a v-shaped slit-like aperture in which the crust frozen, enrobed and lubricated tip 28 has been inserted thereinto. It may be preferable to secure the coaxial section of this alternate embodiment with a skewer.

### CONCLUSIONS, RAMIFICATIONS, AND SCOPE

Accordingly, a meat roast is shown that provides for diners an attractive, reduced fat and gristle, coaxially combined product that may be sliced from the cooked roast or skewered, sliced and grilled or fried. The preferred embodiment also provides a “best of both worlds” meat item in which the most choice sections of the longissimus dorsi and those of the psoas major may be aligned. A Porterhouse steak is usually defined by the diameter of the tenderloin, typically two inches or larger. The current invention will provide from a meat animal carcass approximately 4 times the number of steaks offering this combination, and without the gristle associated with the longissimus dorsi/gludeus medius boundry area.

The foregoing invention has been described in detail by way of illustration and example for purposes of clarity and under standing. However, it will be obvious that certain changes and modifications such as combining solid elongated muscle masses coaxially from different food animals would be possible.

While the foregoing assembly of the invention utilizes a thin knife making a plurality )f cuts in order to incise an aperture of the desired dimension, pre-sized blades of the exact dimension as that of the desired aperture may be constructed in order to perform this step with a single action. Also it may be possible to cut the incision and insert the solid meat mass core with a device similar to that of a larding needle, if which the leading edge of this larding needle type device would incise the larger outer solid meat mass with the proper aperture then leave behind the core meat mass in a similar fashion as that performed when using a larding needle.

These and other variations of the present invention may be practiced within the spirit and scope of the invention, as limited only by the scope of the appended claims and their legal equilivants.

[image]

[image]

[image]

[image]

[image]

[image]

[image]

[image]

[image]

[image]

[image]

[image]

[image]

[image]

[image]

[image]

[image]

[image]

I claim:

1. A coaxially combined meat roast comprising:
a. a first solid elongated muscle meat mass encasing as a core element along substantially the longitudinal axis thereof within a longitudinal slit-like aperture incised therethrough,
b. a second solid elongated muscle meat mass.

2. The coaxially combined meat roast of claim 1 which further includes an edible layer between said first solid elongated muscle meat mass and said second solid elongated muscle meat mass.

3. The coaxially combined meat roast of claim 1 wherin said second solid elongated muscle meat mass is at least laterally, substantially enrobed within a sheet-type or leaf-type vegetable veneer having been wrapped with at least one segment or sheet thereof.

4. The coaxially combined meat roast of claim 3 wherein said first solid elongated muscle meat mass is comprised of a top loin.

5. The coaxially combined meat roast of claim 4 wherein said second solid elongated muscle meat meat mass is comprised of a tenderloin.

6. The coaxially combined meat roast of claim 3 wherein said first solid elongated muscle meat mass is comprised of a rib section.

7. The coaxially combined meat roast of claim 3 wherein said first solid elongated muscle meat mass is comprised of at least a section of boned and trimmed longissimus dorsi.

8. The coaxially combined meat roast of claim 7 wherein said second solid elongated muscle meat mass is comprised of at least a section of boned and trimmed psoas major.

9. The coaxially combined meat roast of claim 3 wherein said coaxially combined meat roast is sliced into steaks.

10. A coaxially combined meat roast comprising;
a. a first solid elongated muscle mass at least partly encasing as a core element along substantially the longitudinal axis thereof within a slit-like aperture incised at least partially therethrough, and said slit-like aperture being of sufficient size to receive therein;
b. a second solid elongated muscle mass.

11. The coaxially combined meat roast of claim 10 which further includes an edible layer between said first solid elongated muscle mass and said second solid elongated muscle mass.

12. The coaxially combined meat roast of claim 11 wherein said first solid elongated muscle mass is a tenderloin from which the tip has been removed and said second elongated muscle mass is the tip.

13. A coaxially combined meat roast comprising;
a. a first elongated solid meat mass encasing substantially as a core element along it's longitudinal axis within a longitudinal aperture incised therethrough;
b. a second elongated solid meat mass.

14. The coaxially combined meat roast of claim 13 wherein said second elongated solid meat mass is enrobed in a leaf or sheet type vegetable veneer.

15. The coaxially combined meat roast of claim 14 wherein said coaxially combined meat roast is sliced into steaks.

16. The coaxially combined meat roast of claim 14 wherein said first elongated solid meat mass is at least a section of top loin.

17. The coaxially combined meat roast of claim 14 wherein said second elongated solid meat mass is at least a section of tenderloin.

18. The coaxially combined meat roast of claim 14 wherein said first elongated solid meat mass is at least a section of longissimus dorsi.

19. The coaxially combined meat roast of claim 18 wherein said second elongated solid meat mass is at least a section of psoas major.

20. The coaxially combined meat roast of claim 14 wherein said second elongated solid meat mass is at least a section of psoas major.
